(19) United States
(12) Patent Application Publication
(10) Pub. No.: US 2017/0327142 A1
(43) Pub. Date: Nov. 16, 2017

(54) SYSTEMS AND METHODS FOR MONITORING WHEELED VEHICLES USING RADIO FREQUENCY IDENTIFICATION (RFID) DEVICES

(71) Applicant: Gatekeeper Systems, Inc., Irvine, CA (US)

(72) Inventors: Stephen E. Hannah, Placentia, CA (US); Jesse M. James, Santa Ana, CA (US); Scott J. Carter, Seal Beach, CA (US)

(21) Appl. No.: 15/645,744

(22) Filed: Jul. 10, 2017

Related U.S. Application Data
(63) Continuation of application No. PCT/US2016/012606, filed on Jan. 8, 2016.
(60) Provisional application No. 62/102,854, filed on Jan. 13, 2015.

(51) Int. Cl. B62B 5/04; G06K 7/10; B62B 5/00; G06K 19/07; G06Q 50/28

(52) U.S. Cl. CPC B62B 5/0423; G06K 7/10297; B62B 5/0096; G06Q 50/28; G06K 19/0707

(57) ABSTRACT

Various embodiments of a system for tracking and/or controlling wheeled vehicles (such as shopping carts), are described. In some embodiments, the system includes an RFID tag on the cart and an RFID reader device external to the cart. The tag can receive an interrogation signal from the reader and reply with a response signal. In various embodiments, the reader or a central control unit can perform various calculations based on the response signal, such as generating a received signal strength indication (RSSI) value. In some embodiments, based on the RSSI value or otherwise, the reader can send a command signal to the tag to take an action, such as to engage a brake mechanism.

### CROSS REFERENCE TO RELATED APPLICATIONS

This application is a continuation of international application no. PCT/US2016/012606, filed Jan. 8, 2016, entitled “SYSTEMS AND METHODS FOR MONITORING WHEELED VEHICLES USING RADIO FREQUENCY IDENTIFICATION (RFID) DEVICES,” which claims the benefit of priority under 35 U.S.C. §119(e) to U.S. Provisional Patent Application No. 62/102,854 filed on Jan. 13, 2015 and titled “SYSTEMS AND METHODS FOR MONITORING WHEELED VEHICLES USING RADIO FREQUENCY IDENTIFICATION (RFID) DEVICES;” each of which is hereby incorporated by reference herein in its entirety.

### BACKGROUND

### Field of the Invention

The present disclosure relates to systems for monitoring the movement and statuses of wheeled vehicles, such as shopping carts.

### Description of Certain Related Art

A variety of commercially available cart containment systems exist for deterring the theft of shopping carts. Typically, these systems include a wire that is embedded in the pavement of a store parking lot to define an outer boundary of an area in which shopping cart use is permitted. When a shopping cart is pushed over this wire, a sensor in or near one of the wheels detects an electromagnetic signal generated via the wire, causing the wheel to lock. To unlock the wheel, an attendant typically uses a handheld remote control to send an unlock signal to the wheel.

### SUMMARY

Some cart containment systems include a radio frequency (RF) transceiver system, in which an RF transceiver in a wheel or wheel assembly of the cart wirelessly communicates with an RF access point. Typically, power is supplied to the RF transceiver by a power source, such as a battery. However, when the power source is depleted or exhausted, the cart may need to be removed from operation for a period of time, so that the power source can be serviced (e.g., replaced or recharged).

The power source may also supply power to other components, such as a brake to inhibit or prevent theft of the cart. However, if the power source is depleted, it may not be able to power the brake. This could result in the brake not engaging, thus rendering the cart vulnerable to theft. Some designs seek to avoid this result by increasing the size of the power supply. But that can undesirably increase the physical size and cost of the system.

Because shopping carts are designed for use in a variety of environments, the RF transceiver on the cart is typically sealed inside a cavity of the wheel or wheel assembly for protection. However, this can increase the chance of interference with other portions of the cart, such as a caster and/or coupling arm (e.g., a fork) that mounts the wheel to the cart. Such interference can inhibit the passage of RF signals between the cart RF transceiver and the access point, which can reduce the speed and/or accuracy of the system's tracking of the carts.

Moreover, sealing the RF transceiver inside the wheel or wheel assembly can add complexity to the manufacturing process. For example, additional time and cost can be required to position the RF transceiver (and related components, such as the power source, antenna, etc.) in the wheel, connect such components to each other, and to seal the wheel around the RF transceiver. Furthermore, some implementations of the RF transceiver require unique features, such as a specialized antenna, which can further increase cost.

Accordingly, it can be desirable to provide a wheeled vehicle communication system that reduces or avoids one or more of the concerns described above or otherwise. In that regard, the present disclosure describes some embodiments of a wheeled vehicle communication system that includes a radio frequency identification (RFID) tag on the wheeled vehicle and an RFID reader (also called a reader device or RFID reader device) positioned external of the wheeled vehicle. The tag (also called a transponder) can include one or more microchips, transceivers, and antennas. In some embodiments, the components of the tag are integrated into a single unit. The tag can receive an interrogation signal from the reader and reply with a response signal. As discussed in further detail below, in various embodiments, the reader or a central control unit can perform various calculations based on the response signal, such as determining (e.g., generating) a received signal strength indication (RSSI) value. In some embodiments, based on the RSSI value or otherwise, the reader can send a command signal to the tag to take an action, such as to engage a brake mechanism.

Various embodiments can reduce the amount of power used by the system. For example, in some embodiments, the RFID tag operates substantially or completely passively. Certain such variants of the RFID tag draw zero or substantially zero power when the RFID tag is not being interrogated by a reader. Thus, in such embodiments, the RFID tag is not continuously depleting the power from an on-board power reservoir, such as a battery, capacitor, or otherwise. As such, the operating time and/or operating distance of the wheel can be extended before the power source needs service (e.g., replacing or recharging).

Further, the use of alternative power supplies can be made feasible by RFID tags. For example, energy harvesters that convert rotational movement of the wheel into electrical energy were previously thought unpractical in the context of wireless communication devices for shopping cart wheels, because such energy harvesters were generally unable to provide sufficient power to the cart RF transceiver. However, in light of the reduced power consumption of the RFID tags, such energy harvesters (e.g., piezoelectric energy harvesters) can now be practically employed in shopping cart wheels.

In some embodiments, the RFID tags and/or the alternative power sources can facilitate the use of segregated and/or dedicated power supplies. As noted above, because the RFID chip can be powered by the energy harvester or another power source that is not an on-board power reservoir, the reservoir can be conserved for other operations. For example, the on-board power reservoir can be dedicated and/or reserved for energizing a brake or other component to inhibit theft of the vehicle. This can reduce the likelihood that the brake will fail to be energized because of depletion of the power reservoir.

Certain embodiments of the RFID tags are configured or positioned to reduce interference. In some implementations, the RFID tag is not located in the cavity of the wheel. For example, in some variants the RFID tag is located in a wall of the wheel, such as a sidewall. This can decrease the chance of interference with other components of the cart, such as the caster of the frame. Thus, the performance and/or reliability of the system can be increased. In some embodiments, the RFID tag may be located outside of the wheel, such as in or on a caster, fork, or housing portion of the wheel assembly.

RFID tags can be more cost effective than non-RFID transceivers. Some RFID tags are less expensive to produce than certain RF transceivers, for example, because the RFID tag does not have a specialized antenna. Some RFID tags are less costly to install in the wheel than RF transceivers. For example, those embodiments in which the RFID tag is formed into the wheel (e.g., in a sidewall) can eliminate the need to an RF transceiver and/or an RFID tag inside the wheel during assembly. Moreover, certain RFID tags are compatible with existing off-the-shelf parts and other existing infrastructure, and thus can reduce the need for costly dedicated infrastructure to support and/or operate the communication system.

The summary above has been provided to briefly synopsize certain features of some embodiments of the present disclosure. However, neither this summary nor the following detailed description purports to define the scope of protection. The scope of protection is defined by the claims.

### BRIEF DESCRIPTION OF THE DRAWINGS

Certain specific embodiments of the invention will now be described with reference to the drawings summarized below. These specific embodiments are intended to illustrate, and not limit, the invention.

FIG. 1 illustrates a perspective view of a retail store and associated property, illustrating an embodiment of a cart monitoring system including RFID tags and RFID readers.

FIG. 2 schematically illustrates a top plan view of an embodiment of the system of FIG. 1.

FIG. 3 illustrates certain communications between the RFID tags and RFID readers of the system of FIG. 1.

FIGS. 4A and 4B illustrate certain interrogation field configurations of the RFID readers of the system of FIG. 1.

FIG. 5 illustrates a perspective view of a wheel that includes some of the components of the system of FIG. 1.

FIG. 6 schematically illustrates some of the electronics that may be included in the wheel of FIG. 5.

FIG. 7 illustrates a side view of the wheel of FIG. 5 with a cover removed to show some of the components that can be contained in the wheel.

FIG. 8 illustrates a perspective view of the wheel of FIG. 5 with an embedded tread wear indicator.

### DETAILED DESCRIPTION OF CERTAIN EMBODIMENTS

The present disclosure describes certain embodiments of a system 10 for communicating with and/or monitoring (e.g., tracking, identifying, analyzing, or otherwise) wheeled vehicles. Some embodiments are described in the context of a human-propelled shopping cart, due to particular utility in that context. However, the subject matter of the present disclosure can be used in many other contexts as well, such as: mobility carts, scooters, wheelchairs, manufacturing or warehouse carts, baggage or luggage carts, medical carts (e.g., hospital carts, medical device carts, stretchers, etc.), strollers, and so forth. The system and/or components thereof can be used for tracking motorized and non-motorized vehicles.

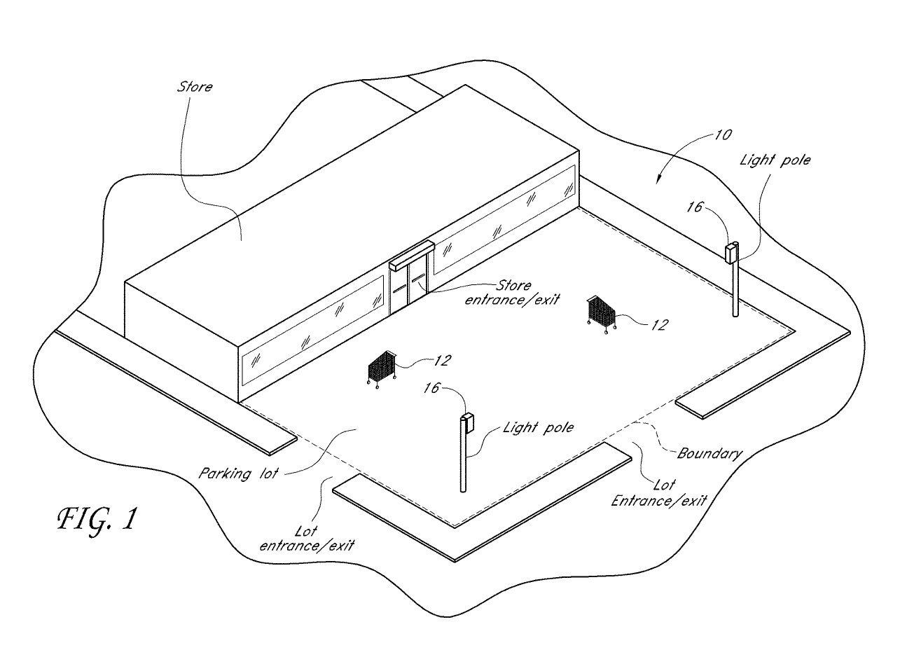

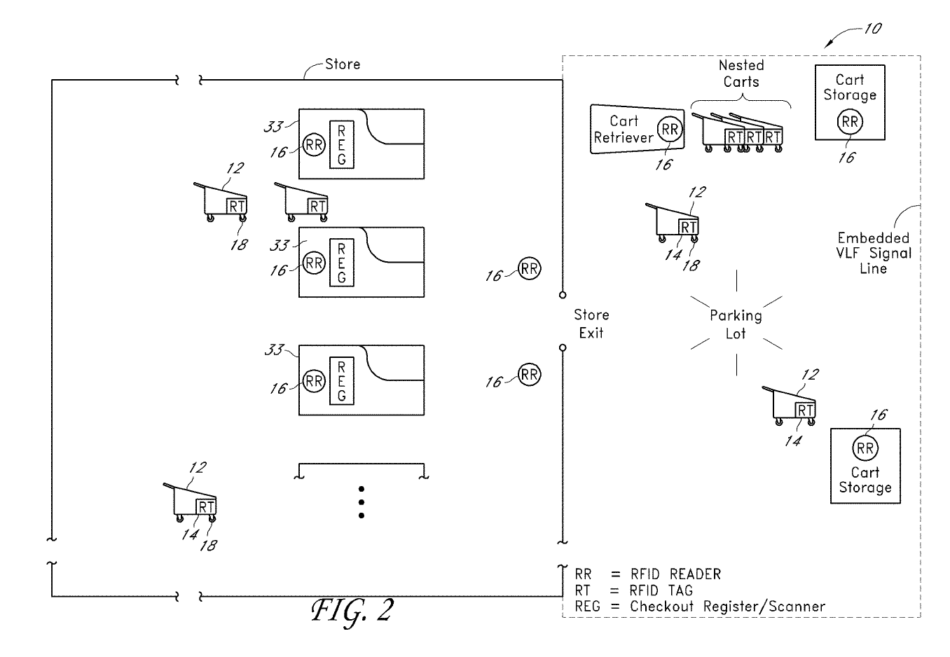

### I. Overview (FIGS. 1 and 2)

As shown in FIG. 1, the system 10 can be used in conjunction with a facility, such as a retail store. Shopping carts 12 can move between the store and an ancillary area, such as a parking lot, via an entry and/or exit door. The parking lot can include a signal line (e.g., a VLF signal line) that defines a boundary, such as the outer boundary of the area in which shopping carts are permitted. The signal line is represented by the dashed line in FIG. 1.

With reference to FIG. 2, the system 10 can include one or more RFID tags 14 that communicate bi-directionally with one or more RFID readers 16. Each tag 14 can include a microchip (e.g., a microcontroller) for storing and/or processing information. Furthermore, each tag 14 can include an RF transmitter and receiver associated with an antenna for transmitting and receiving signals, as discussed in further detail below.

The RFID tags 14 can include any of a variety of types of RFID tags. For example, in some embodiments, each tag 14 is an “active tag,” which substantially continuously receives power from a power source either on-board the tag 14 or the cart 12. Such configurations can facilitate communications between the readers 16 and tags 14 on different frequencies. For example, the readers 16 can transmit very low-level signals and the RFID tags 14 can reply with high-level signals, vice-versa, or otherwise. In certain embodiments, each RFID tag 14 is a “passive tag,” which has no internal power supply and is typically smaller in size and cheaper than the active tag embodiments. Some such variants communicate with the readers 16 by backscattering the signal from the reader 16. In some embodiments, each RFID tag 14 is a “semi-passive tag,” which can communicate with the readers 16 like a “passive tag,” but can also substantially continuously receive power from an on-board power supply like an “active tag.” In some embodiments, the tag 14 derives some or all of its operating power from the signal of the reader 16. As discussed in further detail below, certain embodiments of the tag 14 can have additional components and functionalities, such as various sensors and receivers.

In some embodiments, the tags 14 are each contained within the wheel 18 (e.g., a standard 5-inch diameter shopping cart wheel) of a respective cart 12. As used herein, the term “wheel 18” refers specifically to a wheel assembly that includes electronics as described herein, as opposed to the other wheels or wheel assemblies of the shopping cart. Preferably, the tag 14 is located in one of the front wheels of the cart 12. Some embodiments of the wheel 18 also include a braking unit that can be actuated to lock the wheel 18. An example of a braking unit that may be used for this purpose is described in U.S. Pat. No. 6,362,728, the entire disclosure of which is hereby incorporated by reference.

In some embodiments, certain components are provided on the cart 12 yet outside of the wheel 18. For example, the tag 14 and/or the braking unit can be housed in the wheel assembly (e.g., in the wheel's caster or fork) without being included in the wheel 18 itself. In certain embodiments, the tag 14 and/or the braking unit is located in the frame of the cart 12, such as in a handbar unit.

The readers 16 are typically positioned external to the shopping cart 12. For example, as shown in FIG. 2, certain readers 16 can be located at stationary locations inside the store, such as at a checkout station 33. In some embodiments, each checkout station 33 includes a reader 16, which may be mounted to a preexisting pole (if present) that indicates the number of the checkout station or lane. Each such reader 16 may include a connection or sensor that enables it to determine whether the respective checkout station 33 is currently active. Each reader 16 that is positioned at a checkout station 33 may use a directional antenna to communicate with nearby shopping carts/tags, such as those that are queued in the corresponding checkout lane.

The readers 16 may be mounted to various other fixed and/or mobile structures in the vicinity of the store. For example, as shown in FIGS. 1 and 2, the readers 16 may be mounted to poles (e.g., light poles) and/or to shopping cart storage structures in the store parking lot. Electrical power can be supplied to such readers 16, for example, by a grid electrical power supply or by a solar panel, such as is disclosed in U.S. Pat. No. 8,364,105, the entire disclosure of which is hereby incorporated by reference. These pole-mounted and/or parking-structure-mounted readers 16 may be used to detect and report the number of carts present and/or stored in their respective areas, and may also be used to enable the in-store readers 16 or other network nodes to communicate with tags 14 on cart 12 that would otherwise be out of range.

As illustrated in FIG. 2, the readers 16 may also be mounted on a power-assisted (mechanized) cart retrieval unit or trolley, which may be either a cart pusher or cart puller. One example of such a retrieval unit is the CartManager™ shopping cart pusher sold by Gatekeeper Systems, Inc.

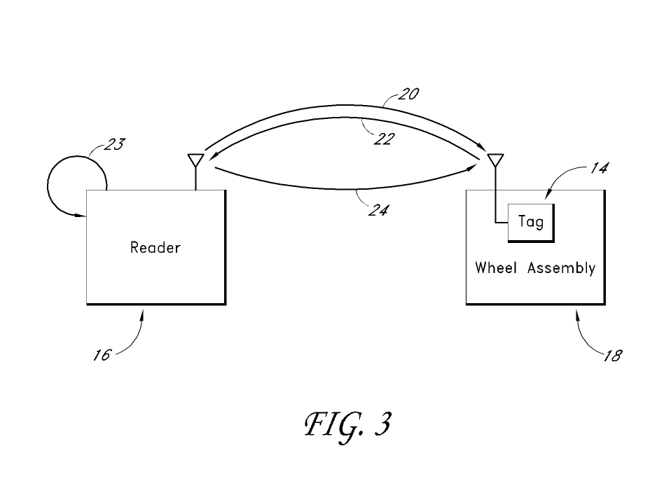

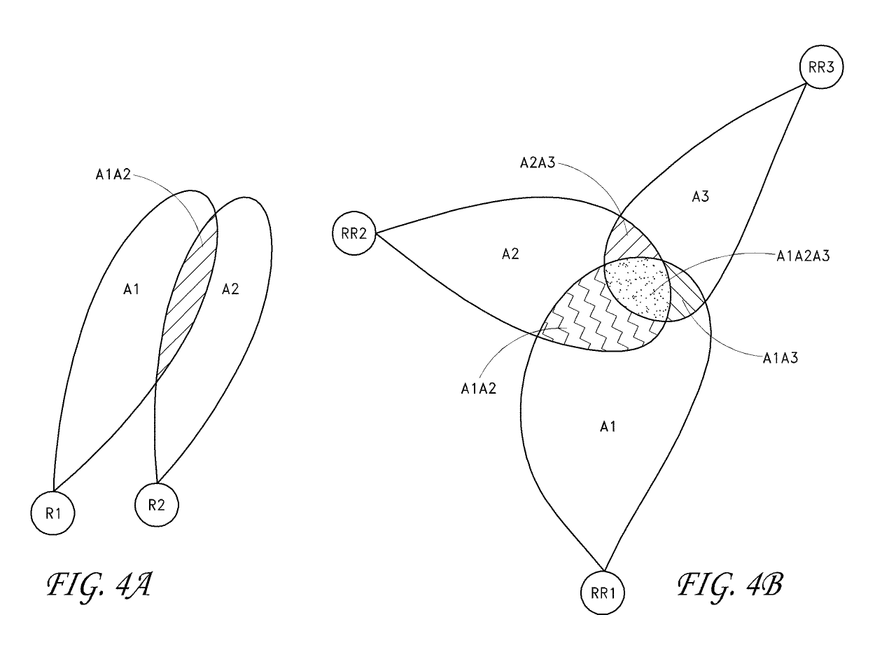

### II. Communication Between Various System Components (FIGS. 3, 4A, and 4B)

The readers 16 can be configured to communicate with the tags 14 for purposes of discerning, monitoring, and/or generating cart status information, such as information related to cart location. Some examples of the types of cart status information that may be discerned, monitored and/or generated include: whether the wheel 18 is in a locked versus unlocked state; whether the cart 12 is moving; average rotation speed of the wheel 18 (as may be sensed using a rotation sensor in the wheel 18); whether the cart has detected a particular type of location-dependent signal such as a VLF, EAS, or magnetic signal; a battery level; a general wheel “health”; and/or the number of lock/unlock cycles experienced by the cart since some reference time.

The readers 16 can be configured to communicate on a network. For example, some or all of the readers 16 can operate as uniquely addressable nodes on a wireless tracking network. In some variants, the readers 16 communicate either directly or via intermediate readers 16 with a central control unit (CCU), which can be a further uniquely addressable node on the network. The central control unit can be implemented as a personal computer that includes a wireless transceiver card or which is wire-connected to one or more of the readers 16. In some implementations, the CCU is generally responsible for collecting, storing and analyzing cart status information, such as location information, gathered by the readers 16. An example of a CCU is disclosed in the aforementioned U.S. Pat. No. 8,364,105.

The readers 16 can be configured to exchange data with the tags 14. For example, the readers 16 and tags 14 can exchange information related to the location or other status information of various individual shopping carts. In some embodiments, each reader 16 is adapted to determine (e.g., generate, calculate, and/or measure) the received signal strength, in terms of a received signal strength indication (RSSI) value, of the transmissions it receives from one or more of the carts 12 (e.g., via the wireless tracking network). For example, a reader 16 can be configured to determine an RSSI value based on a response signal from the tag 14, as discussed in further detail below.

As shown in FIG. 3, the reader 16 can transmit an interrogation signal 20, which can be received by a nearby tag 14. For example, the interrogation signal 20 can be an encoded radio signal to interrogate the tag 14. In certain implementations, the range of the interrogation signal 20 (e.g., the physical area in which interrogation signal 20 is sufficiently strong to interrogate an RFID tag) defines an interrogation field.

The tag 14 can respond to the interrogation signal 20 with a response signal 22. For example, if the interrogation signal is greater than a threshold value (e.g., a minimum signal strength), then the tag 14 can respond with the response signal 22. In various embodiments in which the tag 14 is passive, the RF energy of the interrogation signal 20 can energize the tag 14, which can generate the response signal 22. Certain variants of the response signal 22 comprise a backscatter signal, such as a backscatter of the interrogation signal 20. In some implementations, the response signal 22 is at the same or substantially the same frequency as the interrogation signal 20. In some embodiments, the response signal 22 is a modulated form of the interrogation signal 20. For example, the response signal 22 can be a signal that has been modulated to include information about the wheel 18, such as any of the cart status information described above.

In some embodiments, the response signal 22 is encoded with, or otherwise includes, attributes of the cart and/or wheel 18, such as: a status of the cart 12, status of the wheel 18, and/or status of one or more wheel components (e.g., a braking mechanism, a motor, a gear train, or otherwise). Some variants of the response signal 22 indicate the status of a power reservoir (e.g., a battery), such as the voltage, capacity, charging state, or otherwise. Some variants include the status of an energy harvester, such as whether the harvester is operating, the rate of harvesting, the total amount of energy harvested in a period (e.g., minute, hour, day, week, and/or life of the harvester), or otherwise. In some embodiments, the response signal 22 can provide an indication of tread wear, as discussed below. Some implementations of the response signal 22 can indicate whether there are flat spots on the tread.

The response signal 22 can include and/or provide a globally unique identifier of the tag 14 and/or cart 12. In certain variants, the reader 16 can receive the response signal 22 and use the identifier to identify the tag 14 and/or cart 12. For example, the reader 16 can access a database, look-up table, or the like to correlate the received unique identifier with a particular tag 14 and/or cart 12. In certain embodiments, the database is stored in memory at the reader 16 receiving the response signal 22. In some variants, the database is stored in memory at other readers 16 and/or at the CCU and can be accessed via the network.

In some embodiments, the reader 16 (and/or the CCU) can perform an operation 23 based at least in part on the response signal 22. For example, in some embodiments, the reader 16 uses the response signal 22 to generate an RSSI value. For example, the reader 16 and/or CCU can generate the RSSI value based on the strength of the response signal 22. In various embodiments, the RSSI value is generated (e.g., calculated) external to the wheel 18. This can, for example, reduce the complexity of the electronics and/or programming in the wheel 18.

The system can be adapted to use the RSSI values in many ways. For example, the reader 16 can compare the RSSI value of the response signal 22 to a threshold value to determine whether to respond to the transmission. The reader 16 may also use the RSSI value (together with the RFID tag's unique identification) to enable the system 10 to estimate the location of, or distance to, the tag 14 and the associated shopping cart. As another example, the reader 16 can be adapted to generate RSSI values of transmissions from several nearby tags 14; this information may in turn be used to estimate the number of carts that are in a given area (e.g., queued at a checkout lane, in a cart storage structure, in a cart stack being retrieved with a mechanized cart retrieval unit, or elsewhere). Certain variants of the reader 16 are configured to compare the RSSI value with a threshold. For example, in some implementations, if the RSSI value is less than a threshold, then the reader 16 takes no further action with regard to the response signal 22 (e.g., does not send a further signal for a period of time).

In certain embodiments, the readers 16 can transmit a command signal 24 that can be received by the tag 14. For example, if it has been determined that the cart 12 is in and/or near a restricted area, the reader 16 can generate and/or relay an instruction to the tag 14 to lock the brake mechanism. If the cart 12 has been found to be in, or moving toward, a permitted (e.g., non-restricted) area, the reader 16 can generate and/or relay an order to the tag 14 to unlock the brake mechanism. In some embodiments, the reader 16 can transmit a command signal 24 that instructs a particular tag 14 to activate another component on the cart 12, such as a sign or warning device (e.g., a light or horn).

Accordingly, in some embodiments of the system 10, at least three signals are exchanged between the reader 16 and the tag 14. For example, in certain implementations, at least the interrogation signal 20, the response signal 22, and the command signal 24 are exchanged between the reader 16 and the tag 14. As discussed above, such exchange of signals can facilitate communication of information between the reader 16 and the tag 14. In some variants, the interrogation signal 20 is transmitted (e.g., broadcast) from the reader 16. In reply, the tag 14 can transmit the response signal 22, which can be modulated or otherwise encoded to include a unique identifier as well as other information related to the cart and/or wheel 18. The reader 16 can receive the response signal 22 and can perform various calculations, such as generating an RSSI value of the wheel 18. In certain implementations, the reader 16 can transmit the command signal 24 to the tag 14, thereby instructing the tag 14 to take some action, such as to lock or unlock the brake mechanism of the wheel 18.

In some embodiments, the response signal 22 from a given cart can be received by a plurality of readers 16, such as two readers, three readers, four readers, or more. In certain variants, each of the plurality of readers 16 is configured to perform a calculation based on the response signal 22, such as generating an RSSI value. Because the readers 16 are typically spaced apart from each other, and because the RSSI value can change based on distance from the signal source (e.g., the wheel 18), different readers may generate different RSSI values for the same transmission.

In certain embodiments, some or all of the different RSSI values are compared, such as via the network and/or by the CCU. The comparison of the RSSI values can be used to determine various information about the cart, such as its direction of travel or location. For example, some implementations use the RSSI value from a plurality of readers 16 to trilaterate or triangulate an approximate position of the cart 12. Some variants determine that the cart 12 is nearest to the reader 16 with the largest RSSI value. Certain embodiments determine that the cart 12 is heading toward and/or reducing the distance from those readers in which the RSSI value is increasing over a time period. Some embodiments determine that the cart 12 is heading away from and/or increasing the distance from those readers in which the RSSI value is decreasing over a time period.

As described above, in certain implementations, the range of the interrogation signal 20 from the reader 16 can define an interrogation field. In some embodiments, the interrogation field is the physical space in which the interrogation signal 20 is greater than or equal to a threshold value. In certain implementations, with a plurality of readers 16, some of the interrogation fields can overlap. For example, as shown in FIG. 4A, in an embodiment with two readers R1, R2, certain areas can be located in only one of the interrogation fields, and thus receive the respective interrogation signal 20 from only R1 or R2. Namely, in FIG. 4A, R1 and R2 produce respective interrogation fields that overlap. In some embodiments, in the first area A1, the interrogation signal from R1 is greater than or equal to a threshold value and the interrogation signal from R2 is less than the threshold value. In the second area A2, the interrogation signal from R2 is greater than or equal to the threshold value, and the interrogation signal from R1 is less than the threshold. As shown, in some embodiments, the interrogation fields of both R1 and R2 overlap in an overlapping area A1A2, in which the interrogation signal 20 from both R1 and R2 is received and is greater than the threshold.

In some embodiments, overlapping interrogation fields can be used to determine a location of the cart 12. For example, if the wheel 18 of the cart 12 responds to only the interrogation signal from R1, then the cart 12 can be determined to be in the first area A1. Similarly, if the wheel 18 responds to only the interrogation signal from R2, then the cart 12 can be determined to be in the second area A2. However, when the wheel 18 responds to the interrogation signals from R1 and R2, then the cart 12 can be determined to be in the overlapping area A1A2.

As shown in FIG. 4B, some embodiments have three readers R1, R2, R3 with overlapping regions, A1A2, A1A3, A2A3. Certain variants of such a configuration can determine the position of the cart 12 with better resolution and/or accuracy relative to the two-reader configuration of FIG. 4A. Similar to the configuration discussed above, if the wheel 18 responds to only the interrogation signal from one reader (e.g., R1), then the cart 12 can be determined to be in the area of that reader (e.g., A1). If the wheel 18 responds to the interrogation signals from only two readers (e.g., R1 and R3), then the cart 12 can be determined to be in the overlapping area of the interrogation fields of those readers (e.g., A1A3). If the wheel 18 responds to the interrogation signal from all three readers R1, R2, and R3, then the cart 12 can be determined to be in a common (e.g., centralized) overlapping area A1A2A3 in which the interrogation fields of each of the readers 16 overlap.

As is evident from FIGS. 4A and 4B, in some embodiments, the amount of precision and/or accuracy with which the location of the cart 12 is determined is at least in part a function of the amount of overlap of the interrogation fields. For example, in FIG. 4A, when the wheel 18 responds to the interrogation signals from both R1 and R2, as the extent of overlap between the fields decreases, the precision and/or accuracy with which the location of the cart 12 is determined increases. In various embodiments, the precision and/or accuracy of the location of the cart 12 is a function of the number and/or size of the overlapping areas.

As described above, some implementations of the system 10 are configured to determine the location of the wheel 18 by having one or more of the readers 16 (or the CCU) generate an RSSI value for the response signal 22 from the tag 14. Certain embodiments are configured to determine the location of the wheel 18 in other ways. For example, in some embodiments, the system 10 can determine the location of the wheel 18 based on the relative angle of the response signal 22. In some such variants, at least two readers 16 that are a known distance from each other can measure the angle of incidence or angle of arrival of the response signal 22. Thus, one or more of the readers 16 or the CCU can calculate and/or estimate the location of the wheel 18. In various embodiments, the precision and accuracy of the determination of the position of the cart 12 increases as a function of the number of readers 16 that receive the response signal 22.

In some embodiments, the interrogation signal 20 and/or the command signal 24 can provide instructions to the tag 14 that are programmed into the tag 14. For example, the instructions can be put into a memory on the tag 14, such as in EEPROM or other non-volatile memory. In some embodiments, the programming is done passively, such that the RF energy of the interrogation signal 20 and/or the command signal 24 energizes the tag 14 sufficiently to facilitate putting the instructions into the memory.

In certain variants, programming of the tag 14 can occur when the wheel 18 is in a reduced power or inactive state, such when the wheel has entered a sleep state to conserve power. The programming can thus provide instructions to the tag 14 when the wheel 18 exits the reduced power or inactive state. For example, the programmed instructions can instruct the wheel to transmit a response signal 22 when the wheel 18 exits the sleep state.

Although the tag 14 is a passive tag in certain above-described embodiments, active and semi-active tags are contemplated for use in those and other embodiments as well. In some variants, the tag 14 can receive, detect, or be advised of the interrogation signal 20, and can provide the response signal 22 in reply. Typically, the response signal 22 transmitted by active and semi-active tags is more powerful compared to the response signal 22 of a passive tag. That is because active and semi-active tags typically receive at least some power from an on-board power supply, such as a battery, which can enable a stronger response signal to be emitted compared to some passive tags. The increase in the strength of the response signal 22 signal can increase the communication range of the wheel 18.

In certain active and semi-active tag embodiments, the response signal 22 is unrelated to the form of the interrogation signal 20. For example, in some variants the response signal 22 is not derived directly from the interrogation signal 20. In some embodiments, the response signal 22 is not a backscatter signal (e.g., of the interrogation signal 20). In certain implementations, the response signal 22 is at a different frequency than the interrogation signal 20.

In some active and semi-active tag embodiments, the tag 14 can initiate contact with the reader 16. This is because certain active and semi-active tags do not depend on receiving the interrogation signal 20 to generate the response signal 22. Thus, the signal 22 can be generated independent of the interrogation signal 20 or even in the absence of the interrogation signal 20. This can facilitate communicating information from the tag 14 to the reader 16 without the need for the reader 16 to transmit the interrogation signal 20. For example, in some embodiments, the tag 14 periodically or regularly initiates contact with the reader 16 by transmitting the signal 22 regardless of the presence of the interrogation signal 20.

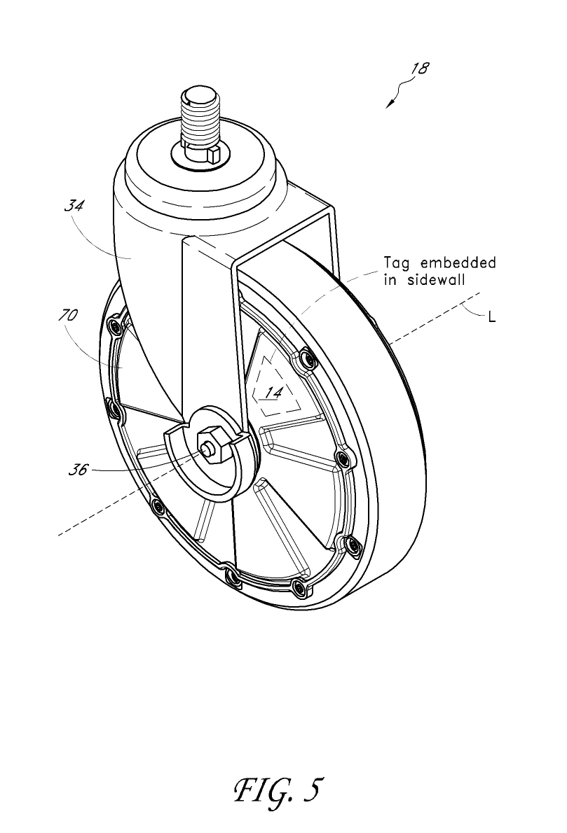

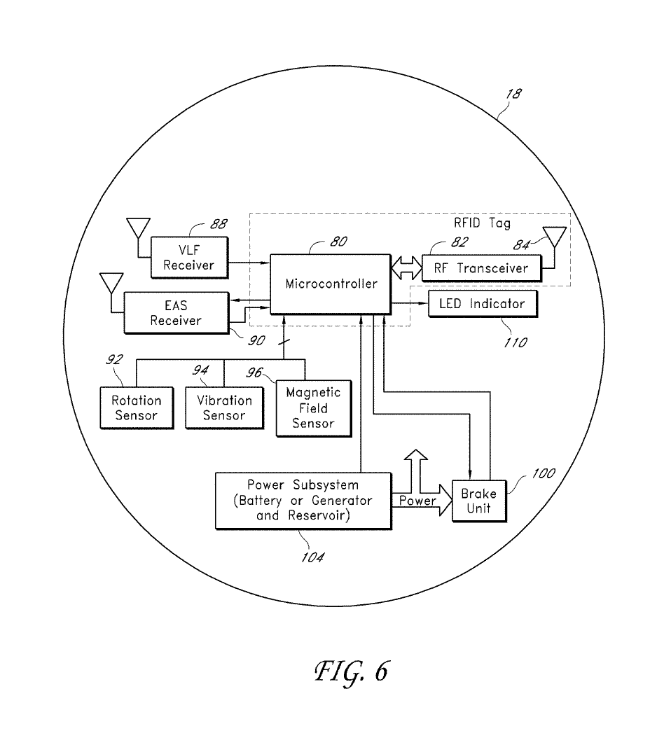

### III. Wheel Components (FIGS. 5 and 6)

FIGS. 5 and 6 illustrate an embodiment of the wheel 18 as well as some of the different types of components that may be provided in or in conjunction with the wheel 18. In some embodiments, all of the components shown in FIG. 5 are mounted inside the shopping cart wheel 18. For example, the tag 14 can be positioned inside a cavity (e.g., hollow, recess, enclosure or the like) of a hub of the wheel 18. As noted above, this can provide protection for the tag 14. The hub can connect to, for example, an axle and/or a caster. In various embodiments, a tread portion extends around a periphery of the hub and contacts the surface along with the wheel 18 rolls (e.g., the ground). The tread portion can be made of a wear resistant material, such as rubber or polyurethane.

In some embodiments, the tag 14 is not positioned inside the cavity of the wheel 18. This can reduce the likelihood of interference with other components of the wheel 18 and or with other components of the cart, such as a caster 34, frame, or otherwise. In certain implementations, such a configuration can result in less interference to the signals 20-24 passing between the tag 14 and the reader 16 and/or can provide a more robust and/or reliable signal. In certain variants, the tag 14 is positioned in the wall of the wheel 18, such as a sidewall 70. For example, the tag 14 can be molded or otherwise formed in the sidewall 70. This can facilitate manufacturability, such as by reducing the number of components to be placed and connected inside the wheel 18.

As noted above, in some embodiments, certain components can be located in a rotating part of the wheel 18 and other components can be located in a non-rotating part of the wheel 18. For example, the tag 14 can be located in a rotating part of the wheel 18, such as the sidewall 70, and the brake mechanism can be located in a non-rotating part of the wheel 18, such as an axle 36 along an axis L. Similarly, in some embodiments, some or all of the operational logic for the wheel 18 can be located in a component (e.g., the RFID tag 14) in one portion of the wheel 18 (e.g., a rotating portion), and a component for performing that logic (e.g., the brake mechanism) could be in another portion of the wheel 18 (e.g., a non-rotating portion).

As noted above, and as shown in FIG. 6, the tag 14 can include a microchip 80 (e.g., a microcontroller) for storing and processing information. The microchip 80 can communicate with an RF transceiver 82. In some variants, the microchip 80 is a low power device that includes a self-programmable flash memory, RAM, and/or a set of integrated peripheral circuits such as an Analog to Digital Converter (ADC) and a multichannel Counter/Timer Circuit (CTC). In some implementations, the microchip 80 and RF transceiver 82 collectively act as a programmable RFID transceiver system. The RFID transceiver system may alternatively be implemented without the use of a separate microchip 80; for example, an IC device that includes both an RF transceiver and a processor. As another example, the microchip 80 could be replaced with another type of controller device, such as a custom ASIC (Application Specific Integrated Circuit).

In certain embodiments, the RF transceiver 82 is capable of receiving transmissions while the microchip 80 is in an inactive state, and waking up the microchip 80 if the received transmission matches pre-programmed criteria. The RF transceiver 82 can be coupled to an antenna 84. In various embodiments, communication between the tag 14 and the reader 16 occurs at a frequency of about 3.1 GHz through about 10 GHz. Some implementations communicate at about 2.4 GHz. Certain embodiments communicate at about 5.7 GHz through about 5.8 GHz.

As illustrated in FIG. 6, in some embodiments, the tag 14 includes a very low frequency (VLF) receiver 88 for detecting VLF signal lines 44. The VLF receiver 88 may, for example, be an approximately 8 kHz receiver that is compatible with existing shopping cart containment systems, and is capable of detecting a code transmitted via a VLF line. In some embodiments, the VLF receiver includes a circular polarized antenna, which can avoid potential interference due to the rotation of the wheel.

Certain variants include an Electronic Article Surveillance (EAS) receiver 90 for detecting EAS tower interrogations. To conserve power, the microchip 80 can maintain the EAS receiver 90 in an inactive state except when certain types of events are detected, such as events evidencing a possible checkout or store exit event. The EAS receiver 90 is preferably tunable by the microchip 80 to the various frequencies commonly used for EAS.

Some embodiments of the microchip 80 are connected to a rotation sensor 92, a vibration sensor 94, and/or a magnetic sensor 96. Certain embodiments of the rotation sensor 92 are implemented using mechanical, optical, and/or electromagnetic components. Some variants of the rotation sensor 92 are configured such that the microchip 80 can detect wheel rotation events. By measuring the number of rotations that occur over a period of time, the microchip 80, reader 16, and/or the CCU, can determine the average rotational speed of the wheel 18 and/or the average translational speed of the cart 12.

The vibration sensor 94, if present, can permit the microchip 80 to detect wheel vibration/skid events commonly caused when a motorized shopping cart retriever 40 pushes or pulls a cart whose wheel is locked or has an improper orientation. Upon detecting a skid event, the tag 14 may transmit an alert message to a nearby reader 16, which in some cases may be a reader 16 mounted to the motorized cart retriever 40. The retriever-mounted reader may respond to such an alert message by generating a signal that disables the cart retriever 40 and/or causes an alarm on the cart retriever 40 to be activated.

The magnetic field sensor 96, if present, enables the microchip 80 to detect magnetic markers. The magnetic sensor 96 may, for example, be one of the following: (1) a two-axis magnetic sensor capable of measuring the value of the two magnetic field components in an object's plane of motion; (2) a “2½ axis” sensor that can measure two magnetic field components and the algebraic sign of a third component, or (3) a three-axis magnetic field sensor that measures each of the three independent magnetic field components. When the magnetic field sensor 96 initially detects a likely magnetic marker in one embodiment, the microchip 80 begins buffering the output of the magnetic field sensor, and continues such buffering until the microcontroller 80 determines that the wheel 18 has likely finished passing over the marker. The tag 14 then transmits the buffered data to a reader 16 for analysis together with wheel rotation-sensor data. The reader 16 or the CCU then analyzes this data to determine whether a magnetic marker was actually crossed, and if so, to identify the unique code of this marker.

Another type of sensor that may be included in the wheel 18 is a heading sensor (not shown) that senses the orientation of the wheel 18, and thus the direction of travel of the cart 12. If a heading sensor is provided, data collected by the rotation and heading sensors may be used in combination by the tag 14, a reader 16, or the CCU to calculate the cart's location relative to one or more known reference points.

Various other types of sensors and receivers may additionally or alternatively be included in the wheel 18 or wheel assembly. For example, some applications include a GPS (Global Positioning System) receiver in the wheel or wheel assembly, or another type of electronic device that is capable of calculating its position based on received RF, optical, or ultrasonic signals. Certain variants of the wheel 18 can transmit a signal that is used by an external node or system to detect the wheel's location, and the wheel could then be notified of its location via an access point.

In some implementations, the microchip 80 generates a drive signal that controls the state of the wheel's braking unit 100, such as by driving a brake motor, to change the locked/unlocked state of the wheel. Decisions to lock the brake may be made by the microchip 80, one or more of the readers 16, and/or the CCU, depending upon the system's configuration and the scenario involved. For example, the microchip 80 may be programmed to automatically lock the wheel, in the absence of a command to the contrary, whenever a VLF or EAS signal is detected. As another example, lock decisions that are not responsive to detection of a VLF or EAS signal may be made by an access point or the CCU. In some embodiments, a braking unit 100 that supports partial braking may be used; in such embodiments, the microchip 80 may gradually engage the brake whenever a lock decision is made so that the cart does not stop suddenly.

As illustrated in FIG. 6, one or both of the tag 14 and the brake unit 100 can be powered by a power subsystem 104. Certain variants of the power subsystem 104 include either a battery, or a power generator that generates power from the rotation of the wheel 18. If a power generator is used, the power can be provided to a capacitor, battery, or other energy reservoir, so that power continues to be supplied to the wheel's active components when the wheel is stopped. As discussed above, some variants of the power subsystem 104 include an energy harvester, such as a device to convert rotational energy of the wheel 18 into electrical energy.

FIG. 6 also depicts an LED indicator 110, which may be provided on a visible portion of the wheel 18 or wheel assembly. This LED indicator may be strobed by the microchip 80 to visually indicate that the cart 30 is in a particular state. For example, if the wheel is currently locked, and a particular type of command is received (e.g., from a reader 16), the microchip 80 may strobe the LED at a low duty cycle for several seconds; this feature may be used to enable store personnel to efficiently identify carts whose wheels are locked. Alternatively, the indicator may be electromechanical, e.g., a highly visible feature, such as a bright orange piece of a suitable material, may be made visible and invisible via an electromechanical device controlled by the microchip 80.

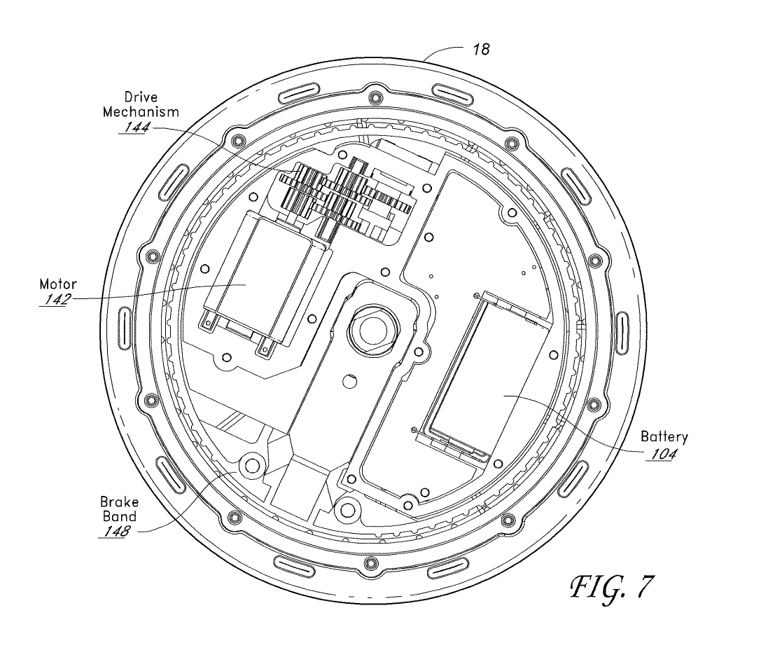

### IV. Power Supplies (FIG. 7)

In several embodiments, the RFID tag 14 is configured to consume very little power. For example, in some embodiments, the tag 14 is only operating (e.g., consuming power) when the wheel 18 is inside an interrogation field of one or more readers 16. In certain embodiments, some or all of the power supplied to the tag 14 is provided by the interrogation signal 20 or another RF signal.

As noted above, in some embodiments, the tag 14 is operatively connected to the energy harvesting mechanism. For example, certain variants of the wheel 18 include a rotational power source that can generate electrical power from the relative movement of components, such as the rotation of the wheel 18 compared to the caster 34 and/or the axle 36. Certain variants of the energy harvesting mechanism can include a first element (e.g., electrode, magnet, or otherwise) on the wheel 18 and a second element on a non-rotating component on the caster 34 or axle 36. As the cart is moved the wheel rotates, which moves the first element relative to the second element, thereby generating electrical power. In some embodiments, the energy harvesting mechanism is a piezoelectric rotational power source. Certain implementations are configured to generate electrical power via magnetic induction. In various embodiments, the energy harvesting mechanism supplies power to only the tag 14. The energy harvesting mechanism can additionally or alternatively be configured to provide power to other components of the wheel 18 and/or the cart 12.

As shown in FIG. 7, some embodiments of the wheel 18 include a power reservoir, such as a capacitor or battery 104. Typically, the battery 104 is configured to contain and/or supply more electrical energy than the energy harvesting mechanism. For example, the battery 104 can contain a greater amount of electrical energy and/or can supply a greater electrical current or potential than the energy harvesting mechanism. In some implementations, the battery 104 is located in a non-rotating location, such as in the axle 36 of the wheel 18. In other embodiments, the battery 104 is located in a rotating portion of the wheel 18. In some implementations, one of the battery 104 and the tag 14 are located in a non-rotating location, and the other is located in a rotating location.

In various implementations, the battery 104 can be operatively connected to one or more components of the wheel 18. This can allow the battery 104 to provide some or all of the power to components (e.g., a brake mechanism) that may require more power than can be supplied by the energy harvesting mechanism. For example, in some embodiments, the brake mechanism receives electrical power from the battery 104, and the tag 14 receives electrical power from the energy harvesting mechanism. This configuration can be beneficial because power for the tag 14 is not being drawn from the battery 104. Rather, the power in the battery 104 can be reserved for the relatively infrequent instances in which the brake mechanism is operated. Thus, such a configuration can reduce the frequency that the battery 104 needs replacement, can increase the likelihood that there is sufficient power in the battery to operate the brake, and/or can provide other benefits.

As shown, the wheel 18 can include a brake motor 142 that drives a drive mechanism 144 (e.g., a set of gears) to control the lock/unlock state of the wheel 18. Some implementations include a drive band 148 that expands and contracts under control of the motor to come into and out of contact with the rotating portion of the wheel 18. All of the internal components mentioned above can be fully contained and enclosed within the wheel (e.g., behind a cover plate that is not shown in FIG. 7) such that they cannot be seen by the user of the shopping cart and cannot easily be tampered with. In other embodiments, some or all of the electronic and braking components may reside outside the wheel 18, such as in an enclosed plastic housing that forms part of the caster 34.

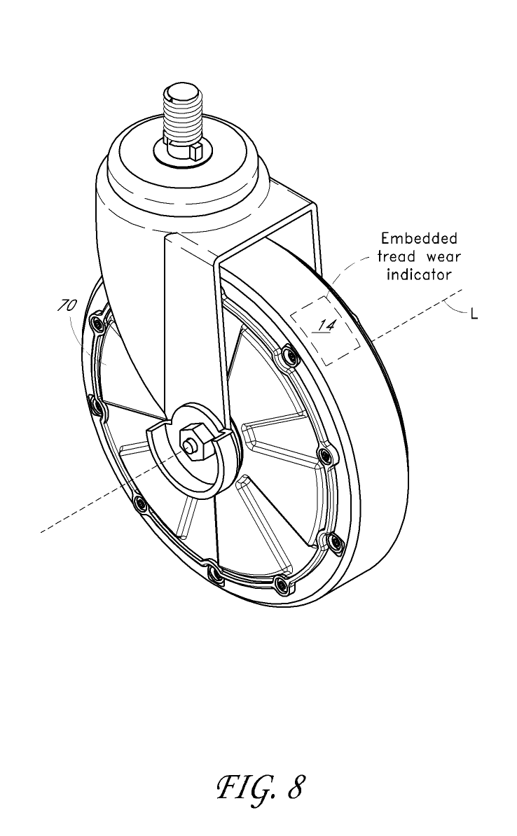

### V. Tread Wear Indicators (FIG. 8)

The tread on the wheel 18 wears (e.g., erodes or otherwise degrades) over time as the cart 12 is used, such as because of abrasion between the tread and the ground. Generally, the tread wears from an initial state to a worn state, during which the radial depth of the tread can decrease. It can be beneficial to identify when the extent of the wear has reached a certain level (or certain levels), so that the tread can be serviced or replaced. This can reduce the chance of the tread becoming overly worn, which can inhibit traction between the cart and the rolling surface (e.g., the ground) and/or can increase the chance of harm to certain of the electrical components of the wheel 18, such as the tag 14 (e.g., due to increased vibration, shock, or otherwise).

As illustrated in FIG. 8, certain implementations of the wheel 18 include one or more components embedded in the tread of the wheel 18. For example, the wheel 18 can include a sensor or other detection mechanism embedded in the tread. Some embodiments are configured such that, as the tread wears, the sensor also wears and/or is increasingly exposed. This can provide a signal or indication, for example, to the tag 14, which in turn can communicate to the reader 16 that the tread is damaged, due for replacement, or otherwise. In some implementations, the sensor comprises an electrical circuit having a portion that is located in the tread and is configured to be eroded as the tread wears. With sufficient erosion the circuit breaks, thereby providing an indication that the tread is worn.

In some embodiments, the wheel 18 includes a sacrificial RFID tag 14′. The sacrificial tag 14′ can be in electrical communication with and/or can be configured to communicate with the tag 14 (also called a non-sacrificial tag). In some implementations, the sacrificial tag 14′ can receive electrical power via the tag 14 and/or from the energy harvester, battery, or otherwise. Similar to the tag 14, the sacrificial tag 14′ can receive and respond to signals from the readers 16.

As described above, the non-sacrificial tag 14 can be located inside the cavity of the wheel 18 or in other locations of the wheel 18, such as in the sidewall 70. In certain embodiments, the sacrificial tag 14′ is embedded in the tread. In some such variants, as the tread is worn down, the sacrificial tag 14′ can also be subjected to wear. With continued wear, the sacrificial tag 14′ can be worn to an extent that it is damaged (e.g., physically eroded) and/or no longer performs certain functions, such as no longer providing a return signal 22′ or otherwise not responding to the reader 16.

In various embodiments the lack of response from the sacrificial tag 14′ can indicate that the tread needs service, replacement or otherwise. For example, in some embodiments, in which the wheel 18 includes the tags 14, 14′, the reader 16 can normally expect to receive two responses to interrogation signal 20: the response signal 22 from the tag 14 and the response signal 22′ from the sacrificial tag 14′. However, with sufficient damage (e.g., wear) to the tread and/or the tag 14′, the sacrificial tag 14′ may no longer be able to provide the response signal 22′. In such a situation, the reader 16 may receive the response signal 22 from the tag 14, but not the response signal 22′ from the sacrificial tag 14′. This can indicate that the tread on the wheel 18 has been worn or otherwise damaged. In some embodiments, the reader 16 can send a signal to indicate that the cart 12 has sustained damage and may be ready for service, replacement, or otherwise. For example, the reader 16 can send a signal to the CCU to alert a user of the damage to the cart 12. The user can be provided the unique identification of the tag 14 and/or the cart 12, which can aid in locating the cart 12 amongst many others.

In some implementations, the system is configured to reduce the likelihood of false positives of an indication of tread wear. For example, in certain embodiments, one or more system components (e.g., the reader 16) makes multiple attempts to receive the response signal 22′ from the sacrificial tag 14′ before issuing an indication that the tread needs service. In some embodiments, one or more system components wait a period of time prior to issuing an indication that the tread needs service. In certain variants, an indication that the tread needs service is not issued until after the cart 12 has been found to have moved a distance (e.g., at least about 1 meter). This can reduce the likelihood that the lack of response from the sacrificial tag 14′ is due to that tag being in a position in which interference with other components (e.g., the castor connected with the wheel 18) inhibits the sacrificial tag 14′ from receiving and/or responding to the reader 16.

Alternate embodiments can be used in various other types of vehicles. For example, the tags 14, 14′ can be positioned in the tire of a car, truck, airplane, or other vehicle. In some embodiments, the sacrificial tag 14′ is located in a car tire and the non-sacrificial tag 14 is located in a hub of the car tire. The RFID reader 16 can be positioned in locations configured to wirelessly communicate with the tags 14, 14′ in the vehicle tire. For example, the RFID reader can be located at a garage, hanger, dock, gate, or service station (e.g., a gas station). This can facilitate testing of whether the tire has become worn or is in need of service. For example, the reader 16 can be positioned at fueling station such that, when a vehicle enters the station, the reader 16 can interrogate one or both of the tags 14, 14′.

### VI. Certain Other Aspects

Certain implementations of the system 10 are configured to detect movement of the cart 12 based on signal phase. The phase of the response signal 22 can be affected by the interrogation signal 20 and/or by the position of the cart 12 relative to the reader 16. For example, in various embodiments, when the wheel is stationary, the phase of the response signal 22 is generally unchanged. However, when the cart 12 is moved relative to the reader 16, the phase of the response signal 22 can change. Certain embodiments of the system 10 are configured to detect such changes in the signal phase and thus determine that the cart 12 is moving. In various embodiments, the tag 14 must be in the interrogation field of the reader 16 in order for the reader 16 to detect the change in the signal phase.

As noted above, some cart containment systems include an RF transceiver in a wheel of the cart that wirelessly communicates with an RF access point. The present disclosure contemplates replacing such RF transceivers and RF access points with the RFID tags 14 and RFID readers 16, respectively. For example, the present disclosure contemplates replacing the non-RFID RF cart transceivers and RF access points of the aforementioned U.S. Pat. No. 8,463,540 (the entire disclosure of which is hereby incorporated by reference) with the RFID tags 14 and RFID readers 16, respectively. Thus, the present disclosure includes all devices, systems, and methods disclosed in the '540 Patent, but with the non-RFID RF cart transceivers and RF access points replaced with the RFID tags 14 and RFID readers 16, respectively.

### VII. Conclusion

Although the present disclosure has been described in terms of certain illustrative embodiments and uses, other embodiments and other uses that are apparent to those of ordinary skill in the art, including embodiments and uses which do not provide all of the features and advantages set forth herein, are also within the scope of the present disclosure. For example, although the tag 14 is described as being a passive tag in some embodiments, active or semi-active tags could alternately be used. Components, elements, features, acts, or steps can be arranged or performed differently than described and components, elements, features, acts, or steps can be combined, merged, added, or left out in various embodiments. Indeed, all possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Some embodiments have been described in connection with the accompanying drawings. The figures are drawn to scale, though such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Any methods described herein may be practiced using any device suitable for performing the recited steps.

Moreover, while operations may be depicted in the drawings or described in the specification in a particular order, it is to be recognized that such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Language of degree used herein, such as “approximately,” “about,” and “substantially,” and the like, represents an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic.

Conditional language used herein, such as “can,” “could,” “might,” “may,” “e.g.,” and the like, unless specifically stated otherwise or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Furthermore, while illustrative embodiments have been described herein, persons of skill in the art would recognize that any and all embodiments having equivalent elements, modifications, omissions, combinations, adaptations and/or alterations are also within the scope of this disclosure.

The following is claimed:

1. A system for tracking a human-propelled vehicle, the system comprising:
a radio frequency identification (RFID) reader device that is configured to transmit a radio frequency interrogation signal, the RFID reader device being positioned a distance apart from the human-propelled vehicle; and
a wheel assembly configured to connect with the human-propelled vehicle, the wheel assembly comprising a passive RFID tag configured to be energized by the interrogation signal and to transmit a response signal in reply, the response signal generated using the energy of the interrogation signal,
wherein the RFID reader device is configured to generate a received signal strength indication (RSSI) value of the response signal, thereby allowing the RFID reader device to approximate a distance between the vehicle and the RFID reader device,
whereby the system is configured to determine the distance between the RFID reader device and the vehicle without the use of battery power within the wheel assembly.

2. The system of claim 1, wherein the RFID reader device is configured to use the RSSI value to determine whether to transmit a command signal to the wheel assembly.

3. The system of claim 2, wherein the command signal instructs the RFID tag to perform an action.

4. The system of claim 3, wherein the action comprises engaging a brake mechanism on the vehicle.

5. The system of claim 1, wherein the response signal includes an identifier for the tag as well as an attribute of the wheel assembly.

6. The system of claim 5, wherein the attribute is whether the wheel assembly needs maintenance.

7. The system of claim 1, wherein the vehicle is a shopping cart.

8. A method for tracking a human-propelled vehicle, the method comprising:
transmitting an interrogation signal with a radio frequency identification (RFID) reader device;
receiving the interrogation signal with an RFID tag positioned in a wheel assembly of the vehicle;
transmitting a response signal with the RFID tag; and
generating a received signal strength indication (RSSI) value of the response signal;
determining the distance between the RFID reader device and the vehicle without the use of a power source within the wheel assembly.

9. The method of claim 8, further comprising energizing the RFID tag with the interrogation signal.

10. The method of claim 8, further comprising determining, based at least on the RSSI value, whether to transmit a command signal comprising an instruction.

11. The method of claim 10, further comprising transmitting the command signal to the RFID tag, and performing the instruction.

12. The method of claim 11, wherein performing the instruction comprises engaging a brake mechanism.

13. A system for tracking a human-propelled vehicle, the system comprising:
a radio frequency identification (RFID) reader device that is configured to transmit an interrogation signal into an area, thereby forming an interrogation field; and
a wheel assembly configured to rotatably connect with the human-propelled vehicle, the wheel assembly comprising an RFID tag having an identifier, the RFID tag being configured such that, when the RFID tag is in the interrogation field, the RFID tag receives the interrogation signal and transmits a response signal in reply, the response signal encoding the identifier of the RFID tag,
wherein the RFID reader device is configured to receive the response signal, generate a received signal strength indication (RSSI) value of the response signal, and determine an appropriate action,
wherein the RFID reader device is configured to transmit a command signal that encodes the appropriate action, and
wherein the RFID tag is configured to receive the command signal and to instruct that the appropriate action be performed by a component of the wheel assembly.

14. The system of claim 13, wherein the RFID tag is a passive tag.

15. The system of claim 13, wherein the system further comprises an energy harvester configured to convert rotational energy of the wheel to electrical energy and to supply the electrical energy to the RFID tag.

16. The system of claim 15, wherein the energy harvester comprises a piezoelectric rotational energy harvester.

17. The system of claim 13, wherein the system further comprises a brake mechanism configured to inhibit movement of the vehicle.

18. The system of claim 17, wherein the appropriate action is to activate the brake mechanism when the vehicle is in an unauthorized location.

19. The system of claim 18, wherein the system further comprises a power reservoir configured to supply power to the brake mechanism.

20. The system of claim 19, wherein the power reservoir comprises a battery.

21. The system of claim 13, wherein the vehicle is a shopping cart.

22. A wear-indicating wheel assembly that is connectable with a vehicle and is configured to roll along a surface, the wheel assembly comprising:
a wheel hub adapted to connect with the vehicle;
a tread portion mated with the hub, the tread portion configured to contact the surface along which the wheel assembly rolls, the tread portion configured to wear between an initial state and a worn state;
a non-sacrificial radio frequency identification (RFID) tag located in the wheel hub, the non-sacrificial RFID tag adapted to communicate with an RFID reader device; and
a sacrificial RFID tag embedded in the tread portion and adapted to communicate with the RFID reader device,
wherein the sacrificial RFID tag is configured to be physically damaged when a predetermined level of wear on the tread portion has occurred, thereby inhibiting the ability of the sacrificial RFID tag to communicate with the RFID reader device, whereby the reader can determine whether the predetermined level of wear has been reached based at least on whether both the non-sacrificial and sacrificial RFID tags respond to an interrogation signal.

23. The wheel assembly of claim 22, wherein the sacrificial RFID tag is molded into the tread portion.

24. The wheel assembly of claim 22, wherein the vehicle is a shopping cart.

25. The wheel assembly of claim 22, wherein the tread portion has a radial depth, the radial depth being greater in the initial state than in the worn state.

26. A wear-indicating wheel assembly connectable with a human-propelled vehicle and configured to roll along a surface, the wheel assembly comprising:
a wheel hub rotatably connectable with the human-propelled vehicle;
a tread portion mated with the hub, the tread portion configured to contact the surface along which the wheel assembly rolls, the tread portion configured to wear between an initial state and a worn state; and
a radio frequency identification (RFID) tag embedded in the tread portion such that:
when the tread portion is in the initial state the RFID tag is not exposed; and
when the tread portion is in the worn state at least a portion of the RFID tag is exposed such that the RFID tag can contact the surface along which the wheel assembly rolls, thereby allowing the RFID tag to be eroded;
whereby the reader can determine whether a predetermined level of wear on the tread portion has been reached based at least on whether the RFID tag responds to an interrogation signal.

27. The wheel assembly of claim 26, wherein the RFID tag is adapted to wirelessly transmit a first signal to the RFID reader device, the first signal indicative of a condition of the tread portion.

28. The wheel assembly of claim 27, wherein:
when the tread portion is in the initial state, the RFID tag transmits the first signal to the RFID reader device; and
when the tread portion is in the worn state, the RFID tag has been sufficiently eroded such that the RFID tag is unable to transmit the first signal to the RFID reader device.

29. The wheel assembly of claim 28, further comprising a second RFID tag, the second RFID tag disposed in the hub and configured to transmit a second signal to the RFID reader device, the second signal indicating an identifier for the vehicle.
